(19) United States
(12) Patent Application Publication
(10) Pub. No.: US 2011/0151276 A1
(43) Pub. Date: Jun. 23, 2011

(54) ANTI TARNISH SILVER ALLOY

(75) Inventors: Sara Wiklund, Gavle (SE); Mikael Schuisky, Sandvilken (SE)

(73) Assignee: Sandvik Intellectual Property AB, Sandviken (SE)

(21) Appl. No.: 13/002,672

(22) PCT Filed: Jul. 3, 2009
(86) PCT No.: PCT/SE2009/050864

§ 371 Date: Mar. 7, 2011

(30) Foreign Application Priority Data
Jul. 7, 2008 (SE) 0801623-0

(51) Int. Cl. B32B 15/04; B32B 5/00; B05D 3/06; C22C 5/06; H01B 1/02

(52) U.S. Cl. 428/673; 428/457; 428/450; 428/472; 428/469; 428/336; 427/551; 420/501; 252/514

(57) ABSTRACT

The invention relates to a coated product comprising a strip substrate comprising a conductive alloy layer comprising silver and indium provided on the surface of the substrate. The conductive alloy layer has good electrical properties and does not easily react with sulphur in the ambient air. The invention further relates to a method for producing a coated product, comprising the steps of: providing a strip substrate; ion-etching of the substrate; depositing a conductive alloy layer comprising silver and indium on the substrate. The invention also relates to a product for electrical use comprising the coated product.

### TECHNICAL FIELD

The present invention relates to a coated product comprising a conductive layer of an alloy comprising silver and indium as well as to a method for producing such a coated product.

### BACKGROUND ART

Metals are by far the largest group of elements; about 80% of all known elements are metals. They are mostly characterized by properties such as high density, high melting point and high electrical and thermal conductivity. They are also ductile and malleable, which together with the other properties make them a very common engineering material and useful in many applications. In electrical applications, the metals silver, copper and gold are often used as contact material due to their high electrical conductivity. Most pure metals are however either too soft, brittle or chemically reactive to be used without modifications, which is why they are often alloyed with other elements. Some pure metals are also very expensive.

Pure copper, for example will react with humid air as well as sulphides in the air to form copper oxides and sulphides, respectively, this will be seen as a green or black layer on the surface. One way to prevent this is to alloy copper with mainly zinc and tin respectively, thus achieving so called brasses or bronzes.

Pure silver is shiny, soft and has the highest electrical conductivity of all metals. Silver, however, suffers from discoloration when exposed to air, but it reacts with sulphides instead of oxygen. This result in the formation of silver sulphide, Ag₂S, which appears as a dark layer on the surface, also called tarnish.

The tarnish rate of silver is highly dependent on the content of sulphur compounds of the ambient air and consequently on the environmental pollution. If a piece of silver is kept in a polluted urban environment it can obtain a dark discoloration in only a few months. The main chemical reaction that results in tarnishing is:

2 Ag+H₂S+½O₂═>Ag₂S+H₂O

However, other reactions involving oxides and sulphates also contribute to the tarnish to some amount.

In order to increase the hardness of silver, it has since long been alloyed with copper. Sterling silver is a common alloy consisting of at least 92.5 wt % silver and 7.5 wt % other metals, usually copper. However, alloying with copper further reduces the tarnish resistance, making the silver alloy even more prone to be discoloured. Tarnish may also affect the conductivity of the material, although it has not been fully explained to what extent.

Previous attempts have been made to find tarnish resistant alloys by mixing silver with other elements e.g. tin or germanium. However, in order to provide the alloy with necessary hardness and malleability it has not been possible to obtain a maximal surface luster of the product.

Products comprising combinations of layers of metals with different properties are known. For example products comprising a layer of metal with high electrical conductivity, such as copper or silver, on an inexpensive substrate of high mechanical strength, such as steel. However, the silver layer in this type of products tarnishes easily during exposure to air. In the field of consumer electronics, such tarnished products are regarded less desirable by the customer. Further drawbacks with such products include poor adhesion of the electrically conductive layer to the substrate as well as low wear resistance of the coating.

There is a need for a coated product with good electrical properties which has a surface, which is resistant to reactions with elements in the environment of the product which does not suffer from the above drawbacks.

### SUMMARY OF THE INVENTION

It is an object of the present invention to provide a coated product with good electrical properties, which has a surface which is resistant to reactions with elements in the environment of the product. The coating should be wear resistant and have good adhesion to the underlying substrate. Another object of the present invention is to provide an effective and inexpensive method of producing such a coated product. A further object of the present invention is to provide a product for electrical use made from the coated product, which has long storage life. Such a product may be an electrical contact such as a spring contact, a tactile metal dome, an interconnector for fuel cells or a back contact for thin film solar cells.

These and other objects have been attained in a surprising manner by the coated product according to the invention, the method for producing the coated product, and its use as a product for electrical applications.

Thus, the invention relates to a coated product comprising a strip substrate and a conductive layer of an alloy comprising silver and indium provided on a surface of said substrate. The silver-indium alloy has a higher driving force to form oxides than to form sulphides. When a silver-indium alloy is exposed to air a very thin layer of indium oxide will therefore be formed on the surface. The thin layer of indium oxide protects the underlying surface from further oxidation or tarnishing caused by reaction with elements in the ambient air. This property, together with the advantage that the addition of indium to silver does not essentially influence the reflectivity of the silver has the effect that the surface of the product appears as a fresh and new even after long-time storage. The good electrical properties of the alloy, makes the product excellent for use in electrical applications e.g. as contact element.

The alloy of the conductive layer may comprise 1-10 wt % In and 90-99 wt % Ag, preferably the alloy may comprise 1-7 wt % In and 93-99 wt % Ag, more preferably the alloy may comprise 3-7 wt % In and 93-97 wt % Ag, most preferably, the alloy may comprise 5 wt % In and 95 wt % Ag. The carefully balanced silver and indium content of the alloy provides for a product with high reflectivity, excellent resistance to tarnish as well as very good electrical properties. An indium content exceeding 10 wt % will lead to reduced anti-tarnishing effect.

An oxide layer may be provided on top of the conductive layer. The oxide layer provides further protection against reaction between the surface of the product and elements in the ambient air. A product with extremely long storage life is thereby achieved. Such a product could also be used in extreme environments e.g. corrosive environments.

The protective oxide layer may be anyone of SiO₂, TiO₂ or Al₂O₃, or a non-stoichiometric sub oxide of SiO₂ such as SiOₓ (x<2), or a non-stoichiometric sub oxide of TiO₂, such as TiOₓ (x<2), or a mixture thereof. These oxides are transparent and provide a dense layer with very good adherence to the underlying conducting layer, thus providing good protection for the conductive layer against elements in the environment.

An oxide layer of up to 50 nm, preferably 5 to 20 nm protects the underlying surface from reaction with elements in the air but does not essentially influence the reflectivity of the underlying surface which appears to be uncoated to the eye.

The product may comprise a layer of nickel closest to the substrate, between the substrate and the conducting layer. The nickel layer provides for improved adhesion of the layers to the substrate.

The invention also relates to a method for producing a coated product, comprising the steps of: providing a strip substrate; ion-etching of the surface of the substrate; depositing a conductive layer of an alloy comprising silver and indium on the substrate. The method provides for effective and inexpensive manufacturing of a coated product with a surface that not easily tarnishes. The method provides for manufacturing of a coated product with good wear resistance due to the excellent adherence of the deposited layers to the substrate.

An oxide layer may be deposited on top of the conductive layer such that the surface is further protected from elements in the ambient air.

The protective oxide layer may be anyone of SiO₂, TiO₂ or Al₂O₃, or a non-stoichiometric sub oxide of SiO₂ such as SiOₓ (x<2), or a non-stoichiometric sub oxide of TiO₂, such as TiOₓ (x<2), or a mixture thereof. Thereby is achieved a method for producing a product which has a transparent, dense oxide layer with very good adherence to the underlying layer, thus providing good protection against elements in the environment.

A layer of Ni could be deposited directly onto the surface of the substrate, such that improved adherence of the following layers to the substrate is achieved.

Preferably, the layers are deposited by electron beam evaporation (EB) under reduced pressure in a continuous roll-to-roll process including in-line ion-etching of the substrate. By performing ion-etching of the surface of the substrate and EB-depositing of the layers under reduced pressure in a continuous roll-to-roll process it is ensured that the layers are deposited directly onto the fresh, un-oxidized strip surface as well as directly onto each other without contact with the ambient air. This provides for very dense layers, which have excellent adherence to each other and to the substrate. Very good wear resistance of the coated product is thereby achieved.

The conductive alloy layer may be deposited by evaporation from a single melt comprising an Ag—In alloy. The method provides for the forming of a conductive coating having a homogenous chemical composition over the surface of the product.

The evaporation is preferably performed under reduced pressure to increase the mean free path for the vapour steam.

Preferably, the evaporation is performed under vacuum with a maximum pressure of 1·10⁻² mbar. Since indium has a slightly higher vapor pressure than silver at a given temperature it is thereby ensured that both elements of the Ag—In alloy are evaporated.

The indium content of the melt should be kept within an interval of 1-10 wt %, preferably 1-7 wt % whereby is ensured that the chemical composition of the coating will be within the desired range. Indium may be continuously supplied to the melt in order to compensate for indium depletion of the melt during the evaporation process.

Alternatively the conductive alloy layer may be deposited by co-evaporation from at least two melts, each melt comprising one element of the alloy. By using co-evaporation the composition of the alloy layer may readily be adjusted.

Preferably, the evaporation rate from each melt is controlled by controlling the temperature of each melt. Thereby is achieved a homogenously deposited coating with a desired chemical composition.

The co-evaporation is preferably performed under reduced pressure to increase the mean free path for the vapour steam.

The deposition of the protective oxide layer is preferably performed under reduced pressure with a partial pressure of oxygen in the range of 1·10⁻⁴-100·10⁻⁴ mbar. As reactive gas H₂O, O₂ or O₃ may be used, preferably O₂.

The EB evaporation may be plasma activated to further ensure hard and dense layers.

The coated product may also be manufactured in a stationary process wherein the substrate first is subjected to ion-etching and the layers thereafter are deposited on the substrate by PVD under a vacuum of 10⁻⁴-10⁻⁸ mbar.

The invention also relates to a product for use in electrical applications made from a coated product according to the invention. The product could be an electrical contact, including spring contacts, tactile domes, interconnectors in fuel cells and back contacts in thin film solar cells. Such a product exhibits very good electrical properties, its surface exhibits a high reflectivity and does not easily react with elements in the ambient air. The product can be stored for a long period of time without that the surface properties of the product changes. Thus, after storage the surface of the product will still exhibit maintained electrical properties and appear as new to the customer.

### BRIEF DESCRIPTION OF THE DRAWINGS

FIG. 1 schematically illustrates a cross-section of coated product according to the invention.

FIG. 2 schematically illustrates a cross-section of a coated product according to the invention including an adhesive nickel layer.

FIG. 3 schematically illustrates the method for manufacturing a coated product according to the invention.

FIG. 4 schematically illustrates a continuous method for manufacturing of the coated product according to the invention.

FIG. 5 schematically illustrates a stationary method for manufacturing of the coated product according to the invention.

FIG. 6 is a diagram describing the relationship between vapour pressure and temperature for In, Ag and Ge.

FIGS. 7, 9 and 11 illustrates the results from tests on tarnishing, reflectivity and contact resistance on samples of a product according to the invention comprising a Ag—In alloy layer.

FIGS. 8, 10 and 12 illustrates the results from comparative tests on tarnishing, reflectivity and contact resistance on samples of a product comprising an Ag—Ge alloy layer.

### DETAILED DESCRIPTION

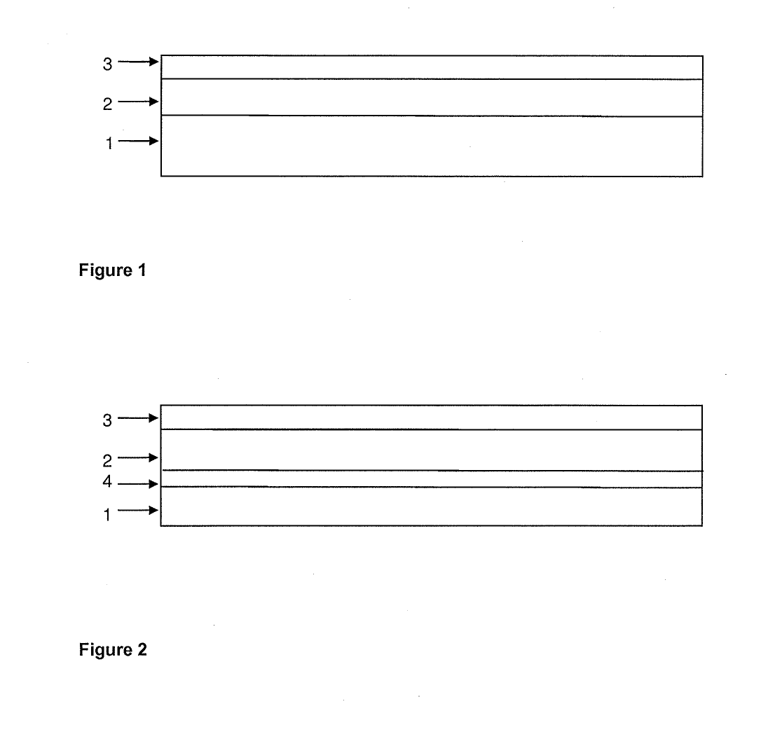

FIG. 1 illustrates a cross-section of a coated product according to the invention. The product comprises a substrate 1 which may be of any type of steel, a martensitic stainless, chromium steel or an austenitic stainless steel but also other metallic materials might be used as a substrate, for example copper and copper alloys, nickel and nickel alloys. The substrate may be of any thickness suitable for the application intended, e.g. 0.03-5.0 mm, preferable not thicker than 1 mm or even more preferred less than 0.8 mm in thickness and have a width of maximum 2000 mm, preferably 800 mm. Normally, the substrate is in the form of a continuous strip having a length from 1 meter up to several thousand meters and is normally provided in a coil. However, the substrate could also be in the form of discrete pieces. A conductive layer 2 of an alloy comprising silver and indium is applied on top of the substrate. The conductive layer exhibits good electrical conductivity.

Electrical conductivity or specific conductivity is a measure of a material's ability to conduct an electric current. Conductivity is the reciprocal (inverse) of electrical resistivity and has the SI units of Siemens per meter (S·m⁻¹) and is also commonly referred to as (cmΩ)⁻¹. Based on their ability to conduct current, materials can be divided into conducting or insulating materials among which metals belong to the conducting materials. A good conductor, suitable for electrical applications, normally has an electrical conductivity measured at room temperature of at least 0.1·10⁶ (cmΩ)⁻¹, preferably greater than 0.16·10⁶ (cmΩ)⁻¹, or even more preferably greater than 0.3·10⁶ (cmΩ)⁻¹.

The conductive alloy may comprise 1-10 wt % In and 90-99 wt % Ag. Preferably, the alloy may comprise 1-7 wt % In and 93-99 wt % Ag. More preferably, the alloy may comprise 3-7 wt % In and 93-97 wt % Ag. Most preferably, the alloy may comprise 5 wt % In and 95 wt % Ag.

The thickness of the alloy layer could be up to several hundred microns but preferably it is less than 10 microns, even more preferred is the thickness of the anti-tarnish silver alloy coating less than 5 microns.

An oxide layer 3 may be applied on top of the conductive alloy layer 2. The protective oxide layer 3 may be anyone of SiO₂, TiO₂ or Al₂O₃, or a non-stoichiometric sub oxide of SiO₂ such as SiOₓ (x<2), or a non-stoichiometric sub oxide of TiO₂, such as TiOₓ (x<2), or a mixture thereof.

The oxide/oxides in the oxide layer 3 are carefully chosen with respect to brittleness, transparency and adhesion to underlying surface and the thickness dimension of the oxide layer is carefully controlled. A dense, transparent oxide layer with good adhesion to the underlying surface is thereby achieved. The oxide layer protects the underlying conducting layer from reaction with elements in the air which would cause the metal surface of the conductive layer to tarnish.

An oxide layer having a thickness of up to 50 nm, preferably 5 nm to 20 nm protects the underlying surface from reaction with elements in the ambient air. However, the thickness of the oxide layer is not greater than that the reflectivity of the underlying surface remain essentially unchanged so that the surface of the conductive metal or alloy layer appears to be clean and uncoated to the eye. The oxide layer is brittle and cannot withstand penetrating forces. The brittleness in combination with the low thickness of the oxide layer makes it easy to penetrate with e.g. a contact element, thus establishing electrical contact with the conductive layer.

The product may comprise a layer of nickel 4, applied directly on top of the surface of the substrate such as described in FIG. 2. The nickel layer 4 provides for improved adhesion between the substrate 1 and the subsequent alloy layer. The nickel layer 4 should be thick enough to provide good adhesion to the underlying surface. Normally the thickness should be 50-1000 nm, preferably less than 200 nm. The conductive alloy layer 2 and eventually an oxide layer 3 are provided on top of the nickel layer as described above.

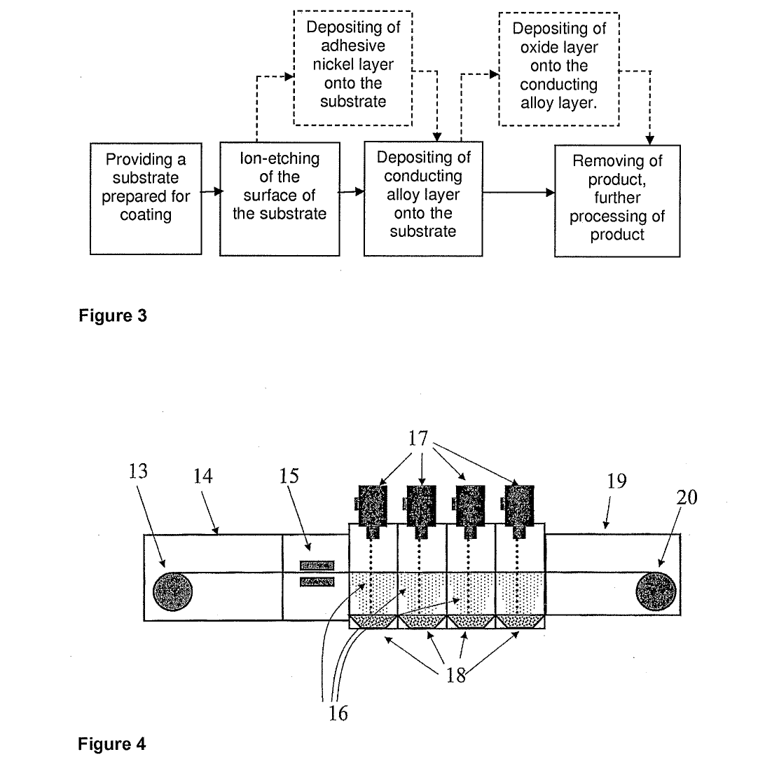

FIG. 3 schematically describes the steps of the method for producing a coated product according to the invention. The method comprises the following steps:
a) Cleaning of the substrate in order to remove oil and grease residues from the strip rolling process. Thus, providing a substrate which is prepared for coating.
b) Ion-etching of the surface of the substrate.
c) Depositing a conductive layer on the surface of the substrate.
d) Subjecting the substrate to further processing into a component.

A nickel layer could optionally first be deposited directly on the surface of the substrate as described with dashed lines in FIG. 3.

An oxide layer may be applied on top of the conductive layer as described with dashed lines in FIG. 3.

A variety of physical or chemical vapour deposition methods may be used to apply the different layers on the substrate. Both continuous and stationary processes could be used. As examples of different deposition methods can be mentioned chemical vapour deposition (CVD), metal organic chemical vapour deposition (MOCVD), physical vapour deposition (PVD) such as sputtering and evaporation by resistive heating, by electron beam, by induction, by arc resistance or by laser evaporation.

For the present invention it is preferred to deposit the layers by electron beam evaporation (EB) under reduced pressure in a continuous roll-to-roll process including in-line ion-etching of the substrate. A roll-to-roll arrangement including ion-etching and electron beam (EB) evaporation chambers as described in FIG. 4 is used to deposit the layers on the substrate.

The roll-to-roll electron beam evaporation arrangement described in FIG. 4 comprises a first vacuum chamber 14 in which an un-coiler 13 for un-coiling a strip shaped substrate is arranged. In pressure tight connection to the first vacuum chamber is arranged an in-line ion assisted etching chamber 15 followed by a series of EB-evaporation chambers 16. The number of EB-evaporation chambers can vary from 1 to 10 chambers in order to deposit several layers on the substrate. All the EB-evaporation chambers 16 are equipped with EB-guns 17 and water cooled copper crucibles 18 for the material to be deposited. Each of these chambers may be provided with equipment for co-evaporation of both Ag and In. The exit of the last chamber is in pressure tight connection to a second vacuum chamber 19 in which a re-coiler 20 is arranged to coil the coated strip substrate. The vacuum chambers 14 and 19 could be replaced by an entrance vacuum lock system and an exit vacuum lock system. In this case, the un-coiler 13 and the re-coiler 20 are placed in the open air.

According to the method a coil of a strip shaped substrate is provided. First of all the surface of the substrate material is cleaned in a proper way to remove all oil residues, which otherwise may negatively affect the efficiency of the coating process and the adhesion and the quality of the coating.

Thereafter the strip is placed in the roll-to-roll arrangement and a vacuum is provided in the first and the second vacuum chambers 14, 19. The strip is continuously un-coiled from un-coiler 13 and is first etched in the ion-etching chamber 15. The ion-etching removes the very thin native oxide layer that normally always is present on a steel surface, thereby is achieved a fresh metal surface on the substrate which provides for very good adhesion of the first layer.

The substrate is thereafter coated in the EB-evaporation chambers 16. The coating material is provided in crucibles in the EB-evaporation chambers 16. During the EB-evaporation the coating material is heated by means of an electron beam from an electron source, focused into the coating material. The focused heat causes the coating material to melt and then to evaporate. The evaporated coating material is then adsorbed on the surface of the substrate and gradually builds up a coating. Several EB-chambers may be arranged in-line. In the first chamber an adhesive layer of nickel may be deposited on the substrate, in the second chamber is a conductive layer of Ag—In alloy deposited. A protective oxide layer may be deposited in a third chamber.

According to one alternative the Ag—In alloy is deposited by the evaporation of a melt of Ag—In alloy provided in one crucible. The evaporation is performed under vacuum with a maximum pressure of 1·10⁻² mbar, whereby is ensured that both elements of the Ag—In alloy are evaporated. As described in FIG. 6, the vapour pressure of indium is slightly higher than that of silver. Since more indium than silver evaporates over time, this will eventually lead to depletion of In from the melt. To compensate for the indium depletion, indium is continuously supplied to the melt, for example in the form of wire or powder. The indium content of the melt should be kept within an interval of 1-10 wt %, preferably 1-7 wt % to ensure that the chemical composition of the coating will be within the desired range.

According to another alternative the Ag—In alloy is deposited by co-evaporation of one melt of Ag and one melt of In. In order to achieve a homogenously deposited coating with a desired chemical composition each element must be evaporated in a correct rate. This is achieved in that the temperature of each melt is strictly controlled i.e. by controlling the effect of the electron beam which heats each melt. The relationship between evaporation rate (vapour pressure) and temperature for each element can be derived from the diagram in FIG. 6.

The deposition of the adhesion nickel layer should also be made under reduced atmosphere at a maximum pressure of 1·10⁻² mbar with no addition of any reactive gas to ensure essentially pure metal layers. The deposition of the protective oxide layer should be performed under reduced pressure with an addition of reactive gas from an oxygen source in the chamber. The partial pressure of oxygen should be in the range of 1·10⁻⁴-100·10⁻⁴ mbar. As reactive gas H₂O, O₂ or O₃ may be used, preferably O₂. The reactive EB evaporation may be plasma activated to further ensure hard and dense layers.

Finally, the coated substrate is coiled on the re-coiler 20. The substrate may subsequently be subjected to further processing such as slitting or stamping into a component of desired shape.

The roll-to-roll deposition arrangement may advantageously be integrated in a strip production line.

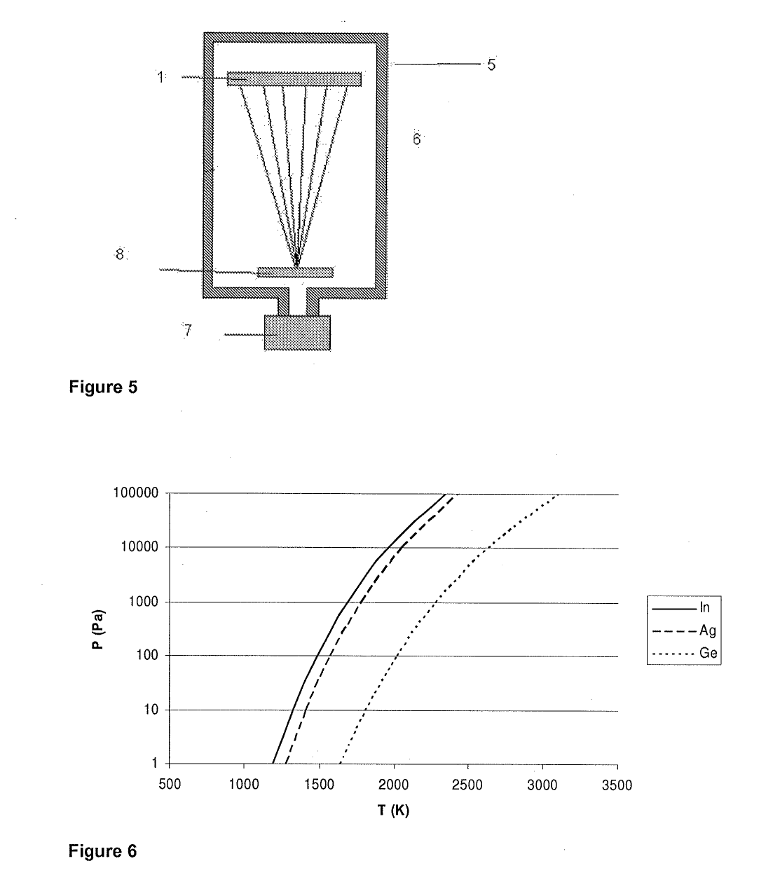

If the substrate is in the form of discrete pieces a stationary process as described in FIG. 5 could be used. The pieces are first cleaned in order to remove oil residues and are thereafter placed in a substrate holder in a chamber 5 of a PVD apparatus 6. A vacuum of 10⁻⁴-10⁻⁸ mbar is provided in the PVD chamber and the substrate is first subjected to ion-etching in order to remove the thin oxide layer on the surface. Next, the substrate is coated with the different layers starting with the nickel layer (if desired), then the conductive Ag—In alloy layer and finally the oxide layer. Each coating material 8 is contained inside the chamber 5 opposite the substrate 1. Normally, the coating materials are provided in molten form in crucibles. The high vacuum may be maintained throughout the coating process, however it is also possible to use controlled amounts of gases e.g. in order to create a plasma. Finally, the substrate is removed from the PVD chamber and subjected to further processing, such as slitting, cutting or stamping.

Heating of the substrate can improve the adhesion of the coating by allowing the atoms to find more energetically favourable positions. A substrate in the form of a discrete piece may be rotated in order to achieve uniform thickness of the coating.

### EXAMPLE

Following is an example of the manufacturing of a coated product according to the invention. The example also show results from measurements made on the coated product.

### Preparation

As substrate material a 0.08 mm thick stainless steel strip of alloy Sandvik 12R11 (ASTM 301) was used. It was cut into pieces of 300×150 mm to fit the substrate holders in the deposition chamber of a PVD apparatus. The pieces were cleaned using the following steps:
Ultrasonic cleaning in a lye bath for 10 minutes at 60° C.
Rinse in warm tap water
Rinse in de-ionized water
Rinse in ethanol
Drying with compressed air

The pieces were handled with gloves to avoid contaminations.

The coating materials to be used in the processes were prepared in crucibles.

### Deposition of Coatings

The crucibles containing coating materials to be used for deposition were placed in the vacuum chamber together with a crucible containing nickel and two steel substrates. An automatic coating process was programmed into the control system of the PVD apparatus. The automatic coating process was started when the pressure in the chamber had reached 1.0·10⁻⁵ mbar. The process included an initial four minutes sputtering with argon gas to further clean the substrates which were heated and rotated. A 50 nm thick nickel layer was first deposited directly onto the substrate to improve the adhesion of the following layers. On top of the nickel layer was an alloy layer deposited. Ag—In alloys of different compositions were deposited as well as different Ag—Ge alloys for comparison. The thickness of the top coatings was 500 nm. One sample was prepared with a SiO₂ top coating. As further comparison, samples were prepared with the pure silver layer left uncoated. Two substrates were coated in each process.

The coatings are shown in table 1.

| | | | Alloy layer | | | |
|---|---|---|---|---|---|---|
| | | Ni-layer | (wt %) | | Alloy layer | SiO₂ top |
| | | thickness | | Alloy | thickness | coating |
| No | Substrate | (nm) | Ag | element | (nm) | (nm) |
| 1 | Stainless | 50 | Ag 90 | In 10 | 500 | |
| | steel | | | | | |
| 2 | Stainless | 50 | Ag 95 | In 5 | 500 | |
| | steel | | | | | |
| 3 | Stainless | 50 | Ag 97 | In 3 | 500 | |
| | steel | | | | | |
| 4 | Stainless | 50 | Ag 99 | In 1 | 500 | |
| | steel | | | | | |
| 5 | Stainless | 50 | Ag 90 | Ge 10 | 500 | |
| | steel | | | | | |
| 6 | Stainless | 50 | Ag 95 | Ge 5 | 500 | |
| | steel | | | | | |
| 7 | Stainless | 50 | Ag 97 | Ge 3 | 500 | |
| | steel | | | | | |
| 8 | Stainless | 50 | Ag 99 | Ge 1 | 500 | |
| | steel | | | | | |
| 9 | Stainless | 50 | Ag 97 | In 3 | 500 | 10 |
| | steel | | | | | |

### Analyses

The following analyses where made on the samples of the coated substrates.

### Tarnish Resistance

Samples of the coated substrates were placed in a sealed glass container with a volume of 20 L. A beaker with 20 g Na₂S was also placed in the container. After 24 hours, the samples were removed from the container and visually inspected.

### Reflectivity

Sheen GlossMaster 60° was used to measure the reflectivity of the coatings. The device determines the gloss of a 15×9 mm area of a sample at 60° angle of incidence and gives the result in gloss units. Since the gloss units range between 0 and 100, the result can be interpreted as reflectivity percentage. The wavelengths used in the device are defined between 380-770 nm, i.e. the visible part of the electromagnetic spectrum.

### Contact Resistance

Strips with dimensions 300×20 mm were cut from the samples to be used for the resistance test. In the test set-up, a Zwick/Roell load machine and a Burster Resistomat 2318 ohmmeter was used. Software TestXpert II was used to process the data. The measuring probe was placed near the surface of the strip and then automatically pushed down, applying increasing predetermined loads while continuously recording the resistance. Waiting time at each of the 26 load points was set to 10 seconds and the final load was 100 N.

### Adhesion

The adhesion of the coatings was tested using standardized method SS-EN ISO 2409. It consists of a cutting device with six sharp and parallel edges that create a grid when two perpendicular cuts are made. A special tape is placed over the grid and removed by hand. The grid is then visually inspected and graded on a scale from 0-5 depending on the amount of affected coating material. The grade “0” is an unaffected surface with very good adhesion, while “5” means that a majority of the surface material has come off.

### Results

### Tarnish Test

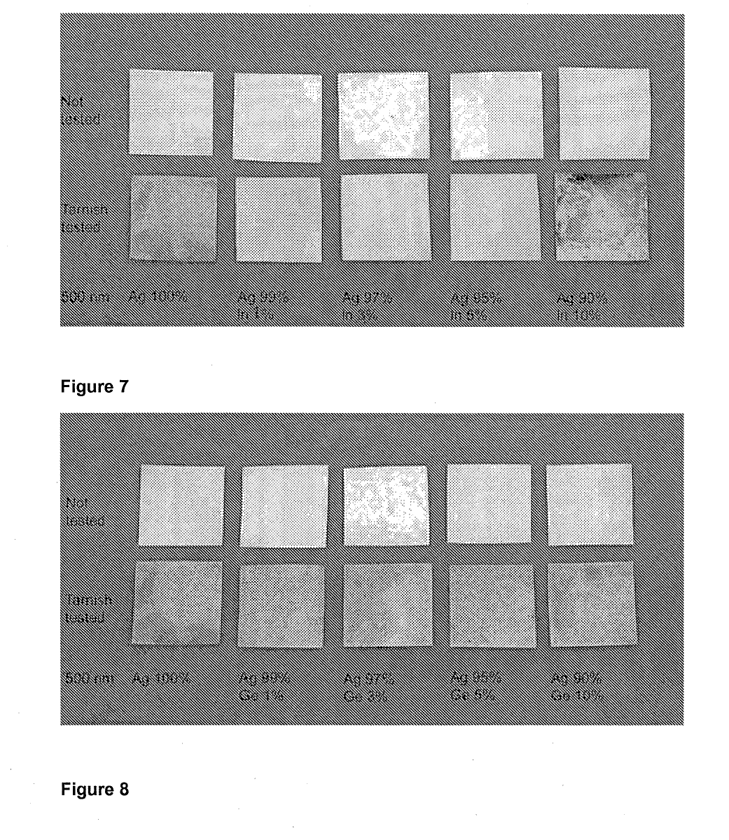

The results of the tarnish test are presented in FIGS. 7 and 8. As can be seen in FIG. 7, very good tarnish resistance was given by the Ag—In alloy.

### Reflectivity

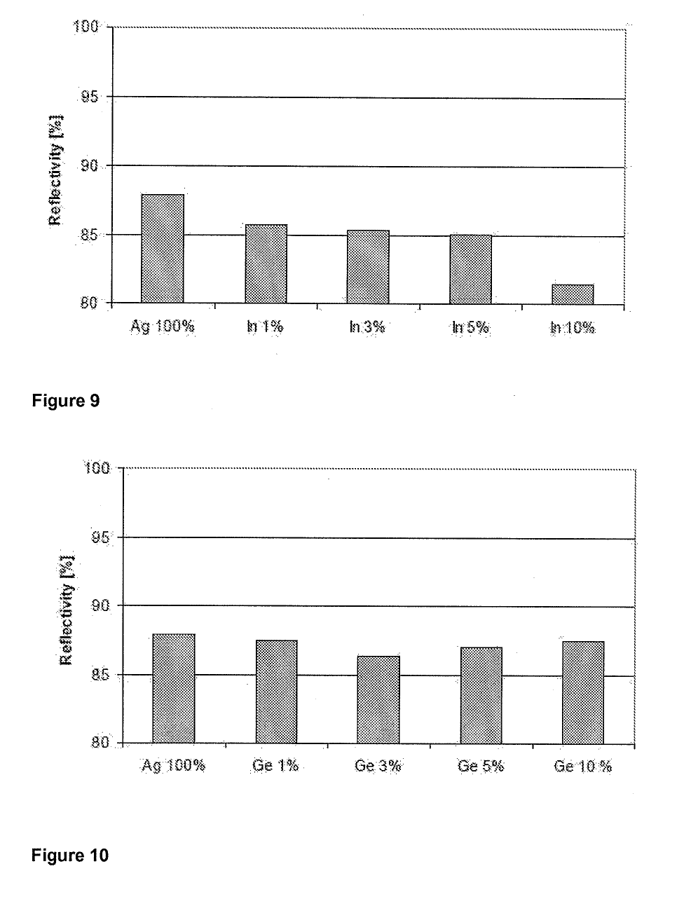

The reflectivity was measured five times on each substrate. The average values are presented in FIGS. 9 and 10. The samples provided with Ag—In alloy exhibited good reflectivity.

### Contact Resistance

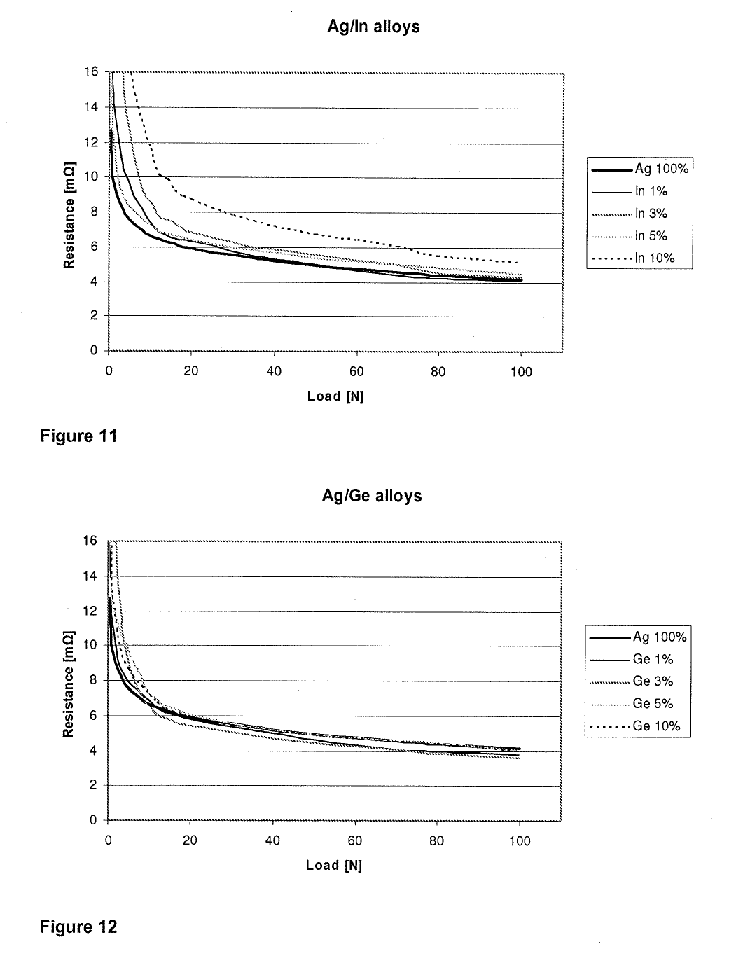

Contact resistance tests were carried out on the samples and the results are presented in FIGS. 11 and 12. Several tests were done on each sample, and the curve that best represented the sample was chosen to be presented. The result for pure silver is also included in the diagram for comparison. It can be seen in FIG. 11 that the contact resistance of the Ag—In alloy only shows a slight deviation from the contact resistance of pure silver.

### Adhesion

The adhesion test showed that the thin top coat of SiO₂, had very good adhesion, grade “0” in the test.

Although particular embodiments have been disclosed herein in detail, this has been done for purposes of illustration only, and is not intended to be limiting with respect to the appended claims. It is obvious that the settings and parameters for controlling the processes described above differs from one case to another and that these settings and parameters are determined by a person skilled in the art. The disclosed embodiments can also be combined. In particular, it is contemplated by the inventors that various substitutions, alterations, and modifications may be made to the invention without departing from the scope of the invention as defined by the claims.

1. A coated product comprising a strip substrate and a conductive layer provided on a surface of said substrate wherein the conductive layer is an alloy comprising silver (Ag) and indium (In).

2. The coated product according to claim 1 wherein the alloy comprises 1-10 wt % In and 90-99 wt % Ag.

3. The coated product according to claim 2 wherein the alloy comprises 3-7 wt % In and 93-97 wt % Ag.

4. The coated product according to claim 1 comprising an oxide layer on top of the conductive layer.

5. The coated product according to claim 4 wherein the oxide layer is anyone of SiO₂, TiO₂, Al₂O₃, a non-stoichiometric sub oxide of SiO₂, a non-stoichiometric sub oxide of TiO₂, or a mixture thereof.

6. The coated product according to claim 4 wherein the thickness of the oxide layer is ≦50 nm.

7. The coated product according to claim 1 wherein a layer of Ni is provided closest to the substrate.

8. A method for producing a coated product, comprising the steps:
a. providing a strip substrate;
b. ion-etching of a surface of the strip substrate;
c. depositing of a conductive layer of an alloy comprising silver (Ag) and indium (In) on the strip substrate;

9. The method according to claim 8 comprising depositing an oxide layer on top of the conductive layer.

10. The method according to claim 8 comprising depositing a layer of Ni directly onto the surface of the substrate below the conductive layer.

11. The method according to claim 8 wherein the layers are deposited by electron beam evaporation (EB) under reduced pressure in a continuous roll-to-roll process including in-line ion-etching of the substrate.

12. The method according to claim 11 wherein the conductive alloy layer is deposited by evaporation from a single melt containing the elements of the alloy.

13. The method according to claim 12 wherein the melt comprises 1-10 wt % In and the rest Ag.

14. The method according to claim 11 wherein the conductive alloy layer is deposited by co-evaporation from at least two melts, each melt comprising one element of the alloy.

15. The method according to claim 14 wherein the evaporation rate from each melt is controlled by controlling the temperature of each melt.

16. A product for use in electrical applications comprising a coated product including a strip substrate and a conductive layer provided on a surface of said substrate, wherein the conductive layer is an alloy comprising silver (Ag) and indium (In).

17. The product according to claim 16 wherein the product is an electrical contact.

18. The product according to claim 16 wherein the product is an interconnector, for use in fuel cell applications.

19. The product according to claim 16 wherein the product is a back contact for use in thin film solar cell applications.

20. The product according to claim 19 wherein the thin film solar cell applications include amorphous silicon based thin film solar cells.
